(19) United States
(12) Patent Application Publication
(10) Pub. No.: US 2012/0293894 A1
(43) Pub. Date: Nov. 22, 2012

(54) SUPERVISION AND PROTECTION FOR AN ELECTRIC CAPSTAN

(75) Inventor: Mingkui ZHENG, Ningbo City (CN)

(73) Assignee: NINGBO CHIMA WINCH CO., LTD., Ningbo City (CN)

(21) Appl. No.: 13/183,394

(22) Filed: Jul. 14, 2011

(30) Foreign Application Priority Data
May 20, 2011 (CN) 201110131990.9
Jun. 16, 2011 (CN) 201120203672.4

(51) Int. Cl. H02H 7/085

(52) U.S. Cl. 361/31

(57) ABSTRACT

A supervision and protection device for an electric capstan that is able to provide an alarm, has good reliability and a long life time, and only requires a short period of time to recover to use after overloading. The supervision and protection device may include an overload signal collection module, a central processing module and an executing module. The overload signal collection module includes a current diverter, one end of which is electrically connected to the negative pole of the DC electrical motor of the electric capstan and the central processing module, and the other end of which is grounded. The executing module includes a sound alert unit and an electrical motor ON/OFF control unit, and the electrical motor ON/OFF control unit is provided to control the start/stop of the ON/OFF unit which is in series connected to the input circuit of the DC electrical motor. The central processing module is also electrically connected to the sound alert unit and the electrical motor ON/OFF control unit.

### CROSS-REFERENCE(S) TO RELATED APPLICATION(S)

This application claims priority to Chinese Patent Application No. 201110131990.9, filed May 20, 2011, and to Chinese Patent Application No. 201120203672.4, filed Jun. 16, 2011, each of which is hereby incorporated by reference in the present disclosure in its entirety.

### BACKGROUND

1. Field

The present disclosure relates generally to electric capstans, and more specifically to methods and devices for supervising and protecting electric capstans.

2. Description of Related Art

For the supervision and protection device for the electric capstan in prior art, the electric motor usually continues rotating when overload of the electric capstan occurs, and thereby power supply can't be cut off immediately. Since the supervision and protection device itself requires heat sinking and the like after being cut off, a long period of time is needed to recover to use. This reduces the reliability and the lifetime of the supervision and protection device, and also inhibits the protection of electric capstan. Since there is no device to alert the user in real time when overload occurs, the user sometimes detects and disposes overload after it has occurred for a period of time. Thus, steel wires easily break and a potential danger of hurting people exists. Also the electric motor is easily burnt out, which makes against the protection of electric capstan.

### BRIEF SUMMARY

One object of the present disclosure is to provide a supervision and protection device for an electric capstan, which is able to alarm, has a good reliability and a long life time, needs a short period of time to recover to use after overloading, and makes for the protection of electric capstan.

The technical solution according to the present disclosure is to provide a supervision and protection device for an electric capstan, including an overload signal collection module, a central processing module and an executing module; the overload signal collection module including a current diverter, one end of which is electrically connected to the negative pole of the DC electrical motor of the electric capstan and the central processing module, and the other end of which is grounded; the executing module including a sound alert unit and an electrical motor ON/OFF control unit, and the electrical motor ON/OFF control unit being provided to control the start/stop of the ON/OFF unit which is in series connected to the input circuit of the DC electrical motor; the central processing module being also electrically connected to the sound alert unit and the electrical motor ON/OFF control unit.

Compared to the prior art, the present disclosure, with such above structure, has the following advantages. The present disclosure determines the operation condition of the electric capstan in accordance with the sampling the current diverter. When the electric capstan is overloaded or approaches to overload, the central processing module may process promptly and command the executing module to take corresponding actions, that is, the sound alert unit performs sound alert to remind the user, and the electrical motor ON/OFF control unit cuts off to stop the electrical motor so that the overload protection of the electric capstan is achieved. When overload is eliminated, the electric capstan may be used again immediately. It takes only 5 seconds for the electric capstan to restart, and user may use the electric capstan again almost without any wait. Thus, it can be seen that the present disclosure enables the electrical motor to stop rotating, so that the defects in current electric capstans are overcome, for example, when a current electric capstan overloading, the electrical motor thereof continuing rotation, power not being cut off, thus causing the steel wires to break or other failures, and resulting in hidden damage. In contrast with the current electric capstan, the present disclosure takes advantages of high sensitivity and precision of shunting resistance sample, and has the sound alert unit to alarm in real time. Therefore, advantageously, the present disclosure is able to alarm, has a good reliability and a long life time, needs a short period of time to recover to use after overloading, and makes for the protection of electric capstan.

As a modification, the present disclosure further includes a sample module for detecting storage batteries voltage, a central processing module and an alert module; the sampling end of the sample module is provided to electrically connect to the positive pole of the storage batteries; the central processing module is electrically connected to the sample module and the alert module. Thus, by applying the voltage of storage batteries to the sample module, the sample module input the signal obtained from sampling to the central processing module, and the central processing module determines whether the storage batteries is normal by comparing with a manually set threshold value. The threshold value may be obtained from prior art, that is, depending on the application requirements of the storage batteries. When the storage batteries are normal, the alert module normally works. In contrast, when the storage batteries are abnormal, the alert module immediately alarms to remind the user of the abnormal storage batteries, and the electric capstan should be closed immediately so as to protect the storage batteries. Thus, it can be seen that the present disclosure is advantageously able to operate while supervising and further protecting the storage batteries. The present disclosure with such above structure can not only provide the electric capstan itself with overload supervision and protection, but also provide the storage batteries with supervision and protection.

As a further modification, the sampling end of the sample module is electrically connected to power supply wires of the electric capstan which are provided to connect to the positive pole of the storage batteries. Once the electric capstan is connected to the storage batteries, the voltage of the storage batteries is applied to the sample module, and the electric capstan can be supervised in real time during the entire operation, and it unnecessary to separately connect cables. Therefore, this is advantageous to implement the present disclosure and improve its performance.

As a further modification, the central processing module includes a signal comparison and amplification unit, a control unit, and a regulated power supply unit; the regulated power supply unit is electrically connected to the signal comparison and amplification unit and the control unit, and the signal comparison and amplification unit is also electrically connected to the control unit; the central processing module being electrically connected to the sample module and the alert module means the control unit being electrically connected to the sample module and the alert module; the electrical connection between one end of the current diverter and the central processing module indicates the electrical connection between one end of the current diverter and the signal comparison and amplification unit; the central processing module also being electrically connected to the sound alert unit and the electrical motor ON/OFF control unit means the control unit also being electrically connected to the sound alert unit and the electrical motor ON/OFF control unit. Since the present disclosure is provided with the regulated power supply unit, it more advantageously can be used with battery cell power supply which is equipped in the transportation (such as vehicle, shipping and the like) itself, so that the reliability of the present disclosure can not be affected by fluctuation of the battery cell voltage.

As a further modification, the alert module includes two LEDs; one end of each LED is electrically connected to the regulated power supply unit, and the other end of each LED is in series connected to a protection resistance and then electrically connected to a collector electrode of a triode; a base electrode of the triode is in series connected to another protection resistance and then electrically connected to the control unit. Since LED economizes on energy, has a long life time and resists abominable environment, this is more advantageous to improve the performance of the present disclosure.

### DESCRIPTION OF THE FIGURES

FIG. 1 is a block diagram showing the principle of a supervision and protection device for an electric capstan according to an embodiment of the present disclosure;

FIGS. 2A and 2B are circuit principle diagrams of the supervision and protection device for the electric capstan according to the embodiment of the present disclosure;

In the figures, reference numeral 1 indicates a sample module, reference numeral 2.1 indicates a signal comparison and amplification unit, reference numeral 2.2 indicates a control unit, reference numeral 2.3 indicates a regulated power supply unit, reference numeral 3.1 indicates a sound alert unit, reference numeral 3.2 indicates an electrical motor ON/OFF control unit, reference numeral 4 indicates an alert module, and reference numeral 5 indicates an overload signal collection module.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

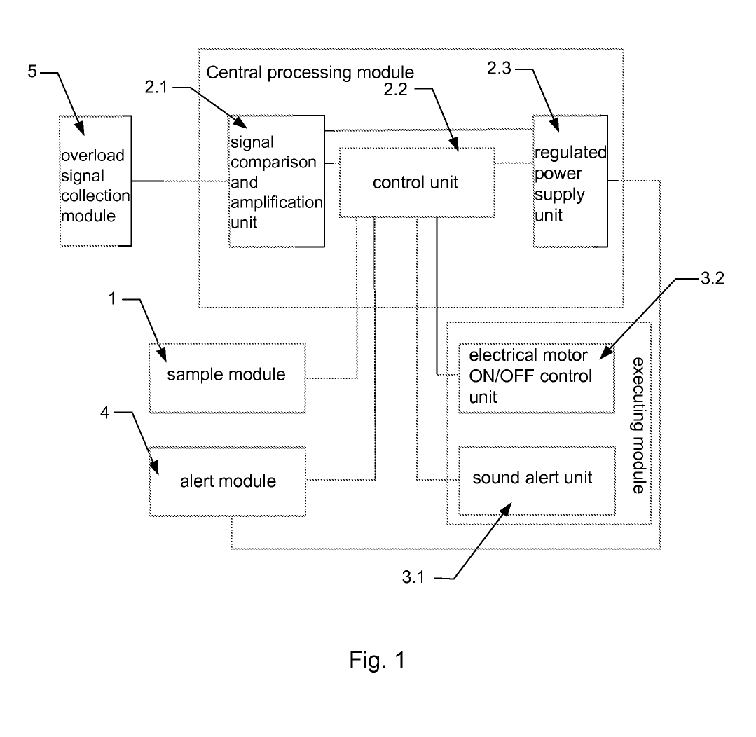

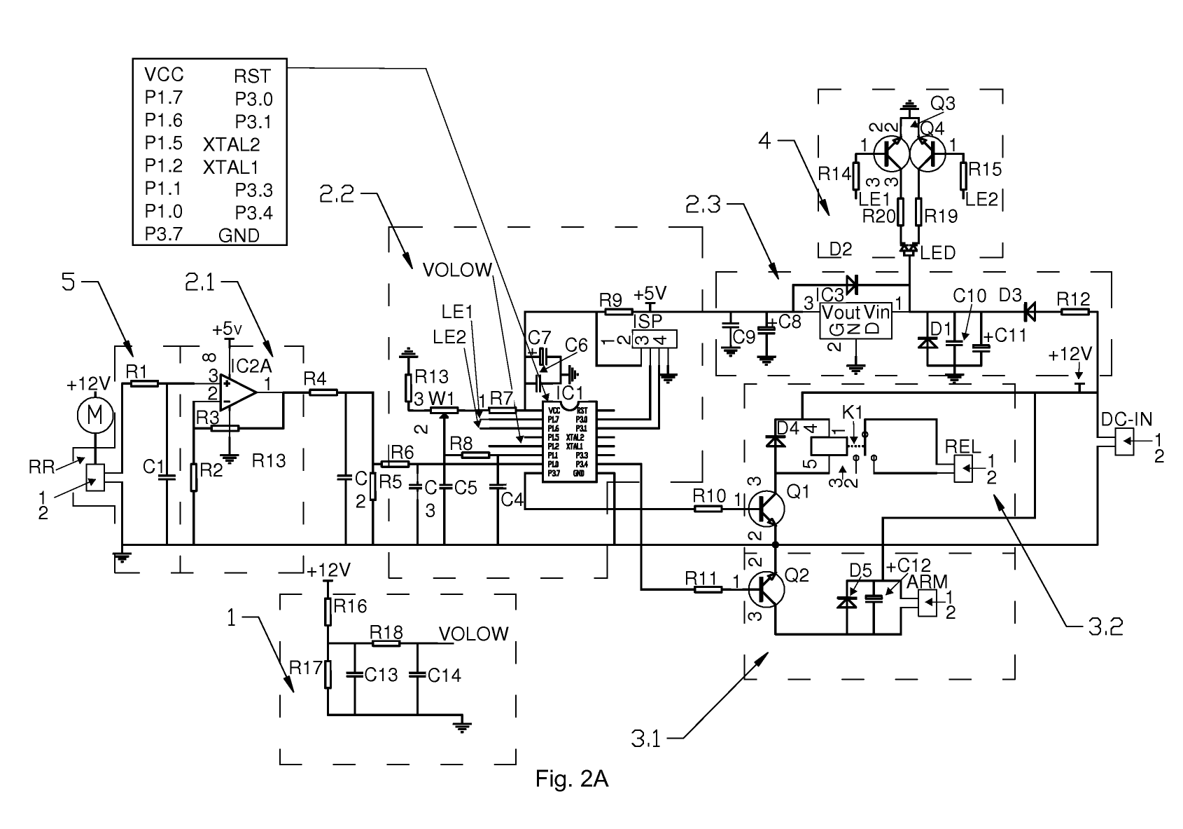

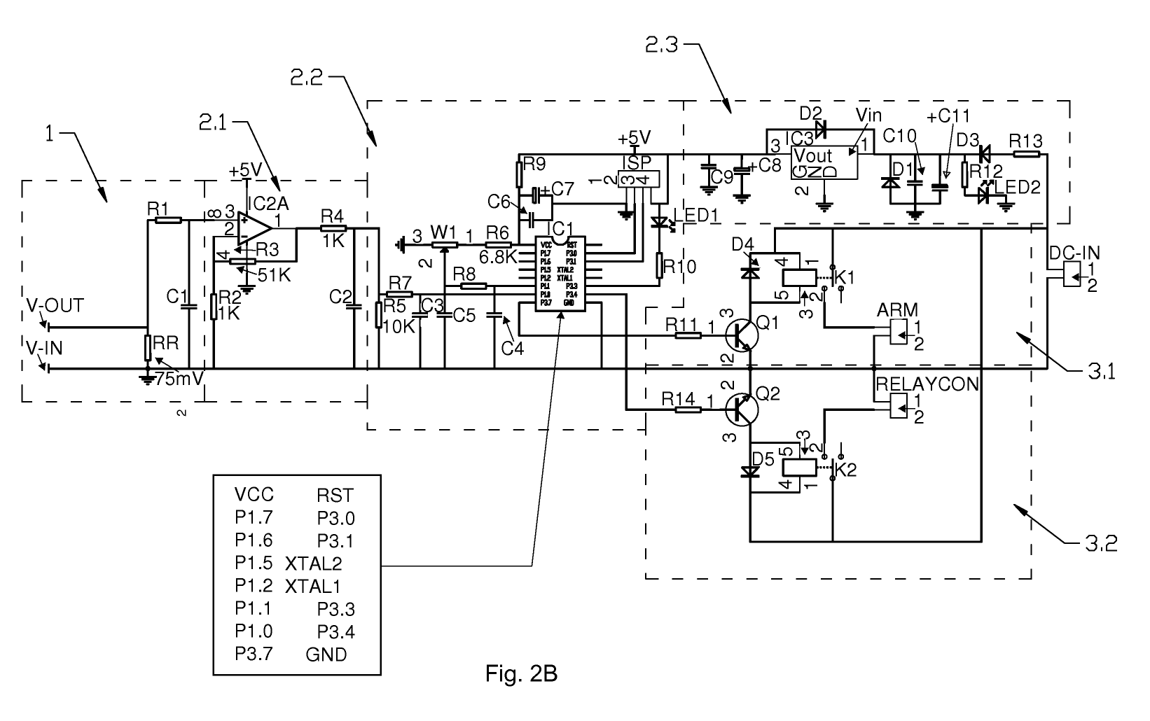

The details of the present disclosure are set forth in accompanying FIGS. 1 and 2(A and B) below.

The supervision and protection device for the electric capstan according to the embodiment of the present disclosure includes an overload signal collection module 5, a central processing module and an executing module. The overload signal collection module 5 includes a current diverter, one end of which is electrically connected to the negative pole of the DC electrical motor of the electric capstan and the central processing module, and the other end of which is grounded. The executing module includes a sound alert unit 3.1 and an electrical motor ON/OFF control unit 3.2. The electrical motor ON/OFF control unit 3.2 is provided to control the start/stop of the ON/OFF unit which is in series connected to the input circuit of the DC electrical motor. The central processing module is also electrically connected to the sound alert unit 3.1 and the electrical motor ON/OFF control unit 3.2.

The supervision and protection device for the electric capstan according to the present disclosure further includes a sample module 1 for detecting storage batteries voltage, a central processing module and an alert module 4. The sampling end of the sample module 1 is provided to electrically connect to the positive pole of the storage batteries. The central processing module is electrically connected to the sample module 1 and the alert module 4.

The sampling end of the sample module 1 is electrically connected to power supply wires of the electric capstan which are provided to connect to the positive pole of the storage batteries.

The central processing module includes a signal comparison and amplification unit 2.1, a control unit 2.2, and a regulated power supply unit 2.3. The regulated power supply unit 2.3 is electrically connected to the signal comparison and amplification unit 2.1 and the control unit 2.2. The signal comparison and amplification unit 2.1 is also electrically connected to the control unit 2.2. The electrical connection between one end of the current diverter and the central processing module indicates the electrical connection between one end of the current diverter and the signal comparison and amplification unit 2.1. The central processing module also being electrically connected to the sound alert unit 3.1 and the electrical motor ON/OFF control unit 3.2 means the control unit 2.2 also being electrically connected to the sound alert unit 3.1 and the electrical motor ON/OFF control unit 3.2. The central processing module being electrically connected to the sample module 1 and the alert module 4 means the control unit 2.2 being electrically connected to the sample module 1 and the alert module 4.

The alert module 4 includes two LEDs. One end of each LED is electrically connected to the regulated power supply unit 2.3, and the other end of each LED is in series connected to a protection resistance and then electrically connected to a collector electrode of a triode. A base electrode of the triode is in series connected to another protection resistance and then electrically connected to the control unit 2.2. The voice broadcast form may be employed to alarm instead of alarming with the light emitted from LEDs. The structure of the voice broadcast as employed may be well known, the detailed description of which can be omitted herein.

In this embodiment, the overload signal collection module 5 further includes a resistance R1 and a capacitance C1. One end of the resistance R1 is electrically connected to an end of the current diverter, the other end of the resistance R1 together along with one end of the capacitance C1 are electrically connected to pin 3 of an operational amplifier IC2A of the signal comparison and amplification unit 2.1, and the other end of the capacitance C1 is grounded. In such configuration, the overload signal collection module 5 has a better sampling reliability.

The embodied circuits of any of the sample module 1, the alert module 4, the signal comparison and amplification unit 2.1, the control unit 2.2, the regulated power supply unit 2.3, the sound alert unit 3.1 and the electrical motor ON/OFF control unit 3.2 may be achieved by well-known technologies. Referring to FIG. 2 in detail, the control unit 2.2 is a single chip. The sound alert unit 3.1 and the electrical motor ON/OFF control unit 3.2 employ triodes Q1 and Q2 to control the output thereof. The triodes Q1 and Q2 are controlled by the single chip. The triode Q1 of the electrical motor ON/OFF control unit 3.2 turns ON/OFF the electrical motor by controlling a relay K1. The relay K1 is an example of the ON/OFF unit. The triode Q2 of the sound alert unit 3.1 achieves the voice output by controlling ON/OFF of a buzzer.

What is claimed is:

1. A supervision and protection device for an electric capstan, the device comprising:
an overload signal collection module,
a central processing module, and
an executing module;
wherein:
the overload signal collection module includes a current diverter, one end of which is electrically connected to the negative pole of the DC electrical motor of the electric capstan and the central processing module, and the other end of which is grounded,
the executing module includes a sound alert unit and an electrical motor ON/OFF control unit, and the electrical motor ON/OFF control unit is provided to control the start/stop of the ON/OFF unit which is in series connected to the input circuit of the DC electrical motor, and
the central processing module is also electrically connected to the sound alert unit and the electrical motor ON/OFF control unit.

2. The supervision and protection device for the electric capstan according to claim 1, further comprising:
a sample module for detecting storage batteries voltage,
a central processing module and
an alert module;
wherein the sampling end of the sample module is provided to electrically connect to the positive pole of the storage batteries; the central processing module is electrically connected to the sample module and the alert module.

3. The supervision and protection device for the electric capstan according to claim 2, wherein:
the sampling end of the sample module is electrically connected to power supply wires of the electric capstan which are provided to connect to the positive pole of the storage batteries.

4. The supervision and protection device for the electric capstan according to claim 1, wherein:
the central processing module includes a signal comparison and amplification unit, a control unit, and a regulated power supply unit;
the regulated power supply unit is electrically connected to the signal comparison and amplification unit and the control unit, and the signal comparison and amplification unit is also electrically connected to the control unit;
the electrical connection between one end of the current diverter and the central processing module indicates the electrical connection between one end of the current diverter and the signal comparison and amplification unit;
the central processing module being electrically connected to the sound alert unit and the electrical motor ON/OFF control unit means the control unit of the central processing module being electrically connected to the sound alert unit and the electrical motor ON/OFF control unit;
the central processing module being electrically connected to the sample module and the alert module means the control unit of the central processing module being electrically connected to the sample module and the alert module.

5. The supervision and protection device for the electric capstan according to claim 2, wherein:
the central processing module includes a signal comparison and amplification unit, a control unit, and a regulated power supply unit;
the regulated power supply unit is electrically connected to the signal comparison and amplification unit and the control unit, and the signal comparison and amplification unit is also electrically connected to the control unit;
the electrical connection between one end of the current diverter and the central processing module indicates the electrical connection between one end of the current diverter and the signal comparison and amplification unit;
the central processing module being electrically connected to the sound alert unit and the electrical motor ON/OFF control unit means the control unit of the central processing module being electrically connected to the sound alert unit and the electrical motor ON/OFF control unit;
the central processing module being electrically connected to the sample module and the alert module means the control unit of the central processing module being electrically connected to the sample module and the alert module.

6. The supervision and protection device for the electric capstan according to claim 4, wherein:
the alert module includes two LEDs; one end of each LED is electrically connected to the regulated power supply unit, and the other end of each LED is in series connected to a protection resistance and then electrically connected to a collector electrode of a triode; a base electrode of the triode is in series connected to another protection resistance and then electrically connected to the control unit of the central processing module.

7. The supervision and protection device for the electric capstan according to claim 5, wherein:
the alert module includes two LEDs; one end of each LED is electrically connected to the regulated power supply unit, and the other end of each LED is in series connected to a protection resistance and then electrically connected to a collector electrode of a triode; a base electrode of the triode is in series connected to another protection resistance and then electrically connected to the control unit of the central processing module.
